(19) United States
(12) Patent Application Publication
(10) Pub. No.: US 2025/0382482 A1
(43) Pub. Date: Dec. 18, 2025

(54) AQUEOUS INK, INK CARTRIDGE AND INK JET RECORDING METHOD

(71) Applicant: CANON KABUSHIKI KAISHA, Tokyo (JP)

(72) Inventors: DAICHI SASAKI, Kanagawa (JP); SATORU KOBAYASHI, Kanagawa (JP); HIROSHI KAKIKAWA, Kanagawa (JP)

(21) Appl. No.: 19/181,447

(22) Filed: Apr. 17, 2025

(30) Foreign Application Priority Data
Apr. 18, 2024 (JP) 2024-067428
Apr. 4, 2025 (JP) 2025-062402

(51) Int. Cl. C09D 11/30; B41J 2/175; C09D 11/033; C09D 11/102

(52) U.S. Cl. CPC C09D 11/30; C09D 11/033; C09D 11/102; B41J 2/17503

(57) ABSTRACT

The present invention provides an aqueous ink for ink jet that enables recording an image high in glossiness and abrasion resistance and is high in intermittent ejection stability. An aqueous ink for ink jet containing a pigment, a water-soluble urethane resin, polyethylene wax, a water-soluble organic solvent and polyethylene glycol. The water-soluble organic solvent contains at least one selected from the group consisting of glycol and glycol ether having a vapor pressure of 1.0 Pa or more at 20° C. and a polar term, δ_{P}, of 10.0 MPa^{1/2} or less as a Hansen solubility parameter. The polyethylene glycol has a number average molecular weight of 200 or more.

### BACKGROUND OF THE INVENTION

### Field of the Invention

The present invention relates to an aqueous ink, an ink cartridge and an ink jet recording method.

### Description of the Related Art

Ink jet recording methods have recently enabled recording high-definition and highly glossy images achieved by silver halide photography and offset printing. Coloring materials for inks include dyes and pigments. Among others, pigments have been widely used as coloring materials from the viewpoint that the pigments enable recording images that are high in fastness such as gas resistance, light resistance and water resistance.

In images recorded on glossy paper with inks containing dyes as coloring materials (dye inks), dye molecules are dissolved in an aqueous medium and absorbed in fixing layers, so that even friction on the surfaces of the images does not scratch the images. In contrast, in images recorded on glossy paper with inks containing pigments as coloring materials (pigments inks), pigments are fixed on the surfaces of glossy paper without being absorbed in the fixing layers, so that friction on the surfaces are likely to scratch the surfaces. Pigment inks therefore need to be improved in abrasion resistance of images to be recorded. Commercial printing or industrial printing requires abrasion resistance immediately after recording under service conditions such that images are contacted immediately after the recording for rapid recording or labels.

For example, Japanese Patent Application Laid-Open No. 2019-202419 proposes an ink containing a water-soluble urethane resin and a wax particle to achieve both glossiness and abrasion resistance. Japanese Patent Application Laid-Open Nos. 2023-060416 and 2021-070239 describe inks containing a water-soluble urethane resin and a wax particle.

### SUMMARY OF THE INVENTION

The present invention is directed to providing an aqueous ink for ink jet that enables recording an image high in glossiness and abrasion resistance and is high in intermittent ejection stability. The invention is also directed to providing an ink cartridge and an ink jet recording method using this aqueous ink.

That is, according to one aspect of the invention, the present invention provides an aqueous ink for ink jet containing a pigment, a water-soluble urethane resin, polyethylene wax, a water-soluble organic solvent and polyethylene glycol, wherein the water-soluble organic solvent contains at least one selected from the group consisting of glycol and glycol ether having a vapor pressure of 1.0 Pa or more at 20° C. and a polar term, δ_{P}, of 10.0 MPa^{1/2} or less as a Hansen solubility parameter, and the polyethylene glycol has a number average molecular weight of 200 or more.

Further features of the present invention will become apparent from the following description of exemplary embodiments with reference to the attached drawings.

### BRIEF DESCRIPTION OF THE DRAWINGS

FIG. 1 is a sectional view illustrating an embodiment of an ink cartridge of the present invention schematically.

FIG. 2A is a perspective view of the main parts of an ink jet recording apparatus illustrating an exemplary ink jet recording apparatus for an ink jet recording method of the present invention schematically.

FIG. 2B is a perspective view of a head cartridge illustrating an exemplary head cartridge of an ink jet recording apparatus for an ink jet recording method of the present invention schematically.

### DESCRIPTION OF THE EMBODIMENTS

Hereinafter, the present invention will be described in further detail with reference to preferable embodiments. If a compound is a salt in the present invention, the salt is dissociated into ions in an ink, but the expression “the salt is contained in the ink” is used for convenience. The aqueous ink for ink jet may be described merely as an “ink”. The values of physical properties are values at normal temperature (25° C.) unless otherwise specified. The description “(meth)acrylic acid” as used herein means “acrylic acid or methacrylic acid”. As used herein, a unit constituting a resin refers to a repeating unit derived from one monomer

According to studies by the present inventors, it has been revealed that the image recorded with the ink proposed in Japanese Patent Application Laid-Open No. 2019-202419 has satisfactory abrasion resistance after the image is left to stand for 24 hours at normal temperature, but the image has low abrasion resistance immediately after the recording. Meanwhile, it has been revealed that the images recorded with the inks described in Japanese Patent Application Laid-Open Nos. 2023-060416 and 2021-070239 have certain, but insufficient, effects on the abrasion resistance immediately after recording, and that the inks have low “intermittent ejection stability”.

The intermittent ejection means that an ink is ejected without operation for recovering the recording head after an ink is not ejected from the ejecting orifice of the recording head in the ink jet system for a long period of time. In such a case, moisture and others in the ink evaporate from the ejection orifice, resulting in the thickening of the ink or the adherence of the ink to the nozzle. Upon the attempt to eject the ink from the ejection orifice again without recovery operation, the ink is first ejected unsteadily or not ejected, so that the image is likely to be noisy. Such a condition mentioned herein is expressed as low “intermittent ejection stability”.

To complete the present invention, the present inventors have therefore earnestly examined an aqueous ink for ink jet that enables recording an image high in glossiness and abrasion resistance and is high intermittent ejection stability, an ink cartridge and an ink jet recording method using the aqueous ink.

An ink containing a water-soluble urethane resin and polyethylene wax enables recording an image high in glossiness and abrasion resistance. However, according to the examination by the present inventors, it has been found that the abrasion resistance of the image immediately after the recording and the intermittent ejection stability varies depending on the selection of the type of the water-soluble organic solvent to be incorporated into the ink. The present inventors have noticed two parameters as characteristics of the water-soluble organic solvent that influence these performances. First, the present inventors have noticed the vapor pressure of the water-soluble organic solvent from the viewpoint of volatility. Since the water-soluble organic solvent having high vapor pressure is highly volatile, and is likely to evaporate even immediately after recording, the solvent can have a certain effect on the abrasion resistance of the image immediately after the recording.

Second, the present inventors have noticed the polar term δ_{P} of the Hansen solubility parameters (hereinafter referred to as the “polar term δ_{P}”) of the water-soluble organic solvent from the viewpoint of polarity. In a pigment dispersion liquid, a pigment having hydrophilic surfaces is dispersed in water. A pigment dispersion liquid therefore has high compatibility with a highly polar water-soluble organic solvent, namely a water-soluble organic solvent having a high polar term, δ_{P}, as a Hansen solubility parameter. If a water-soluble organic solvent having a high polar term, δ_{P}, as the Hansen solubility parameter is incorporated into an ink, the pigment is likely to remain dispersed due to high compatibility between the water-soluble organic solvent and the pigment dispersion liquid even in the case of an increase in the concentration of the water-soluble organic solvent due to the evaporation of moisture from the ink near an ejection orifice.

Meanwhile, a pigment dispersion liquid has low compatibility with a water-soluble organic solvent having low polarity, namely a low polar term, δ_{P}, as the Hansen solubility parameter. If a water-soluble organic solvent having a low polar term, δ_{P}, as the Hansen solubility parameter is incorporated into an ink, the evaporation of moisture from the ink near an ejection orifice increases the concentration of the water-soluble organic solvent, so that the pigment is less likely to remain dispersed due to low compatibility between the water-soluble organic solvent and the pigment dispersion liquid. Consequently, this promotes the movement of the pigment dispersion liquid to portions that has higher compatibility, containing moisture at high concentration, and is distant from the ejection orifice. Even though the ink is not ejected from the ejection orifice for a long period of time, this phenomenon reduces the concentration of the pigment, resulting in a decrease in the viscosity of the ink, so that the ink is high in intermittent ejection stability.

The present inventors have earnestly examined based on the above-mentioned two viewpoints as criteria for selecting the water-soluble organic solvent to evaluate the glossiness and the abrasion resistance of the image and intermittent ejection stability of the ink thereby. Consequently, it is made clear that an ink of interest can be obtained using at least one water-soluble organic solvent selected from the group consisting of glycol and glycol ether having specific vapor pressure and a specific polar term, δ_{P}, and the polyethylene glycol having a number average molecular weight of 200 or more. That is, the ink uses at least one selected from the group consisting of glycol and glycol ether having a vapor pressure of 1.0 Pa or more at 20° C. and a polar term, δ_{P}, of 10.0 MPa^{1/2} or less as the Hansen solubility parameter as the water-soluble organic solvent. The use of the glycol and/or the glycol ether having specific vapor pressure and a specific polar term, δ_{P}, and the polyethylene glycol has a number average molecular weight of 200 or more enables obtaining the ink that enables recording an image high in glossiness and abrasion resistance and is high in intermittent ejection stability.

The detailed examination will be then described. It has been first found that the use of the water-soluble organic solvent having a vapor pressure of 1.0 Pa or more at 20° C. and a polar term, δ_{P}, of 10.0 MPa^{1/2} or less as the Hansen solubility parameter improves the abrasion resistance of the image immediately after the recording and the intermittent ejection stability to a certain degree. However, even the use of a water-soluble organic solvent other than glycol and glycol ether has vapor pressure of 1.0 Pa or more and a polar term, δ_{P}, of 10.0 MPa^{1/2} or less as the Hansen solubility parameter enhances neither abrasion resistance nor intermittent ejection stability increases to desired performances.

In order to improve the intermittent ejection stability, the present inventors have accordingly examined whether a water-soluble organic solvent having relatively low vapor pressure could be used to suppress excessive evaporation at the ejection orifice. Consequently, the examination has shown that it is effective to use polyethylene glycol as the water-soluble organic solvent having relatively low vapor pressure. That is, it has been found that the intermittent ejection stability is improved in an ink containing the glycol and/or the glycol ether having a vapor pressure of 1.0 Pa or more at 20° C. and a polar term, δ_{P}, of 10.0 MPa^{1/2} or less in combination with polyethylene glycol. Further examination has made it clear that the use of polyethylene glycol having a number average molecular weight of 200 or more greatly also improves the abrasion resistance of the image immediately after the recording while greatly improving the intermittent ejection stability.

As described above, the water-soluble urethane resin and the polyethylene wax are incorporated into an ink to enable recording an image high in glossiness and abrasion resistance. The glycol and/or the glycol ether having a vapor pressure of 1.0 Pa or more at 20° C. and a polar term, δ_{P}, of 10.0 MPa^{1/2} or less and the polyethylene glycol having a number average molecular weight of 200 or more are further incorporated into the ink. The present inventors assume the reason why this results in the compatibility between the abrasion resistance and the intermittent ejection stability while maintaining the glossiness of the image immediately after the recording to be as follows.

It is assumed that since the polyethylene glycol, which is likely to interact with glycol or glycol ether, having C—O bonds similarly, makes the glycol or the glycol ether having high vapor pressure remain in the ink system, the evaporation from the ejection orifice is suppressed. Moreover, it is conceivable that since the glycol or the glycol ether having a low polar term, δ_{P}, as the Hansen solubility parameter promotes the movement of the pigment dispersion liquid to portions distant from the ejection orifice effectively, the viscosity of ink does not increase, so that sufficient intermittent ejection stability is obtained.

Meanwhile, it has been found that even though the polyethylene glycol, having low vapor pressure, is incorporated into the ink, the polyethylene glycol having a number average molecular weight of 200 or more allows the image to achieve satisfactory abrasion resistance immediately after the recording. Although no one has clarified the reason why the use of polyethylene glycol, having low vapor pressure, improves the abrasion resistance immediately after the recording, the present inventors assume the following. It is conceivable that moisture evaporates from an image recorded on a recording medium with the ink to form associations through the hydrogen bonding between hydrophilic groups, for example, urethane bonds and polyol moieties, of the water-soluble urethane resin and ether bonds of the polyethylene glycol. It is believed that the formation of the associations reduces the polarity of the water-soluble urethane resin to strengthen the interaction between the water-soluble urethane resin with reduced polarity and low polar polyethylene wax. It is considered that the polyethylene wax and the associations of the low polar polyethylene glycol and the water-soluble urethane resin are then abundant exclusively on the surface of the image to form a strong film, resulting in improving the abrasion resistance immediately after the recording sufficiently. The polyethylene glycol is believed to form the associations with the water-soluble urethane resin to weakly interact with the glycol or the glycol ether. It is conceivable that the glycol or the glycol ether with high vapor pressure is likely to evaporate even immediately after the recording to make the abrasion resistance immediately after the recording satisfactory unlike at the ejection orifice. If the polyethylene glycol has a number average molecular weight of less than 200, the abrasion resistance immediately after the recording is deteriorated. It is assumed that this is due to the following reason: The polyethylene glycol with a number average molecular weight of less than 200 permeates the recording medium, so that the above-mentioned effect is not produced.

### Ink

The aqueous ink for ink jet of the present invention contains a pigment, a water-soluble urethane resin, polyethylene wax, a water-soluble organic solvent and polyethylene glycol. Hereinafter, the components constituting the ink will be described in detail.

### (Coloring Material)

The pigment is used as a coloring material to be incorporated into the ink. The content (% by mass) of the coloring material in the aqueous ink is preferably 0.10% by mass or more to 15.00% by mass or less, further preferably 1.00% by mass or more to 10.00% by mass or less based on the total mass of the ink.

Specific examples of the pigment include inorganic pigments such as carbon black and titanium oxide; and organic pigments such as azo pigments, phthalocyanine pigments, quinacridone pigments, isoindolinone pigments, imidazolone pigments, diketopyrrolopyrrole pigments and dioxazine pigments. The pigment may be used alone or in combination two or more.

Examples of a usable pigment include a resin-dispersed pigment, containing a resin as a dispersant, or a self-dispersible pigment, having a hydrophilic group bonded to the surface of the pigment particle. Examples of the usable pigment also include a resin-bonded pigment having a resin-containing an organic group chemically bonded to the surface of the pigment particle, or a microcapsule pigment, in which the surface of the pigment particle is covered with resin. Among these, pigments dispersed in different modes can also be used in combination. It is preferable to use especially a resin-dispersed pigment, in which resin as a dispersant is physically adsorbed on the surface of the pigment particle.

It is preferable to use a resin dispersant that enables dispersing the pigment in the aqueous medium by the action of an anionic group as the resin dispersant for dispersing the pigment in the aqueous medium. Resin having an anionic group can be used as the resin dispersant. It is preferable to use resin as described below, especially water-soluble resin. The mass ratio of the content (% by mass) of the pigment in the aqueous ink to the content (% by mass) of the resin dispersant is 0.3 or more to 10.0 or less.

Examples of a usable self-dispersible pigment include a self-dispersible pigment in which an anionic group is bonded to the surface of the pigment particle directly or through another atomic group (—R—). Specific examples of the other atomic group (—R—) include linear or branched alkylene groups having 1 to 12 carbon atoms; arylene groups such as a phenylene group and a naphthylene group; a carbonyl group; an imino group; an amide group; a sulfonyl group; an ester group; and an ether group. The other group may be a group into which these groups are combined.

Examples of the anionic groups stated in the description of the resin dispersant and the self-dispersible pigment include a carboxylic acid group, a sulfonic acid group and a phosphonic acid group. The anionic groups may be in the acid form or the salt form. If the anionic groups are in the salt form, the anionic groups may be partially or completely dissociated. If the anionic group is in the salt form, examples of the cation as the counter ion include alkali metal cations, ammonium ions and organic ammonium ions.

### (Water-Soluble Urethane Resin)

The ink contains the water-soluble urethane resin. The “water-soluble resin” mentioned herein shall be present in an aqueous medium without forming a particle that can be measured for particle diameter by dynamic light scattering if the resin is neutralized with alkali that is equivalent to the acid value. It can be determined according to the method shown below whether a resin is water-soluble. First, liquid containing the resin (solid content of resin: 10% by mass) neutralized with alkali (for example, sodium hydroxide or potassium hydroxide) equivalent to the acid value thereof is provided. Then, the provided liquid is 10 times (based on volume) diluted with pure water to prepare a sample solution. The resin in the sample solution is measured for particle diameter by dynamic light scattering. If any particle having measurable particle diameter is not detected, it can be determined that the resin is water-soluble. In this case, the measurement conditions can be set as follows.

### [Measurement Conditions]

Set Zero: 30 seconds
Number of measurements: 3
Measurement time: 180 seconds

A particle size analyzer using dynamic light scattering (for example, the trade name “UPA-EX150”, which is available from NIKKISO CO., LTD.) is usable as the particle size distribution measuring apparatus. Naturally, the particle size distribution measuring apparatus and the measurement conditions to be used are not limited to the above. If urethane resin having a form in which the urethane resin having measurable particle sizes is present in the aqueous medium, for example, a urethane resin emulsion (urethane resin particle), is incorporated into ink instead of the water-soluble urethane resin without incorporating the water-soluble urethane resin into the ink, the glossiness of the image is deteriorated.

The content of the water-soluble urethane resin (% by mass) in the aqueous ink is preferably 0.10% by mass or more to 15.00% by mass or less based on the total mass of the ink. The above-mentioned content (% by mass) of the water-soluble urethane resin is more preferably 0.50% by mass or more to 10.00% by mass or less, further preferably 0.50% by mass or more to 3.00% by mass or less. The above-mentioned content of the water-soluble urethane resin means the content in one ink. If the content of the water-soluble urethane resin in the ink is in the above-mentioned range, the glossiness of the image can be further improved.

The water-soluble urethane resin preferably contains at least one unit selected from the group consisting of a unit derived from polyethylene glycol and a unit derived from polypropylene glycol. If the water-soluble urethane resin has the above-mentioned unit, the interaction with the polyethylene glycol in the ink can be strengthened to further improve the abrasion resistance of the image immediately after the recording. The polyethylene glycol and the polypropylene glycol can be used as the below-described polyol having no acid groups in the synthesis of the water-soluble urethane resin.

The water-soluble urethane resin may be a water-soluble acrylic urethane resin containing a unit derived from (meth)acrylic acid and/or a unit derived from alkyl (meth)acrylate ester. The “water-soluble urethane resin” as mentioned herein shall also include water-soluble acrylic urethane resin. It is however preferable that the water-soluble urethane resin contains neither the unit derived from (meth)acrylic acid nor the unit derived from alkyl (meth)acrylate ester. If the water-soluble urethane resin does not have the above-mentioned acrylic unit(s), the water-soluble urethane resin is likely to be highly polar to strongly interact with the polyethylene glycol in the ink, resulting in enhancing the abrasion resistance of the image immediately after the recording. The urethane resin containing a unit derived from (meth)acrylic acid and/or the unit derived from alkyl (meth)acrylate ester is referred to as acrylic urethane resin.

For example, polyisocyanate can be reacted with a component (polyol or polyamine) that reacts therewith to obtain the water-soluble urethane resin. A crosslinking agent or a chain extender may be further reacted therewith to obtain the water-soluble urethane resin. A water-soluble urethane resin containing a unit derived from polyisocyanate, a unit derived from polyol not having an acid group and a unit derived from polyol having an acid group is preferable as the water-soluble urethane resin.

The polyisocyanate is a compound having two or more isocyanate groups in the molecular structure thereof. Examples of polyisocyanate include aliphatic polyisocyanate and aromatic polyisocyanate. One or more thereof can be used.

Specific examples of the aliphatic polyisocyanate include polyisocyanates having chain structures such as tetramethylene diisocyanate, hexamethylene diisocyanate, dodecamethylene diisocyanate, 2,2,4-trimethylhexamethylene diisocyanate, 2,4,4-trimethylhexamethylene diisocyanate, lysine diisocyanate, 2-methylpentane-1,5-diisocyanate and 3-methylpentane-1,5-diisocyanate; and polyisocyanates having cyclic structures (alicycle group polyisocyanate) such as isophorone diisocyanate, hydrogenated xylylene diisocyanate, 4,4′-dicyclohexylmethane diisocyanate, 1,4-cyclohexane diisocyanate, methylcyclohexylene diisocyanate and 1,3-bis(isocyanatomethyl)cyclohexane. One or more of the above-mentioned aliphatic polyisocyanate can be used for the synthesis of the water-soluble urethane resin.

Specific examples of the aromatic polyisocyanate include tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, dialkyldiphenylmethane diisocyanate, tetraalkyldiphenylmethane diisocyanate and α,α,α′,α′-tetramethylxylylene diisocyanate. One or more of the above-mentioned aromatic polyisocyanate can be used for the synthesis of the water-soluble urethane resin. Among the above-mentioned polyisocyanates, aliphatic polyisocyanate is preferable, alicyclic polyisocyanate is more preferable, and isophorone diisocyanate is further preferable.

The polyol is a compound having two or more hydroxy groups in the molecular structure thereof. Examples of the polyol include polyols not having acid groups such as polyether polyol, polyester polyol and polycarbonate polyol; and polyols having acid groups. One or more of the above-mentioned polyols can be used for the synthesis of the water-soluble urethane resin.

Examples of the polyether polyol include an addition polymer of alkylene oxide and polyol; and glycols such as (poly)alkylene glycol. Examples of the alkylene oxide include ethylene oxide, propylene oxide, butylene oxide and α-olefin oxide. Examples of the polyol to be addition-polymerized with the alkylene oxide include diols such as 1,3-propanediol, 1,3-butanediol, 1,4-butanediol, 1,5-pentanediol, 1,6-hexanediol, 3-methyl-1,5-pentanediol, 2-butyl-2-ethyl-1,3-propanediol, 1,4-cyclohexanediol, 1,4-cyclohexanedimethanol, 4,4-dihydroxyphenylpropane, 4,4-dihydroxyphenylmethane, hydrogenated bisphenol A, dimethylolurea and derivatives thereof; and triols such as glycerin, trimethylolpropane, 1,2,5-hexanetriol, 1,2,6-hexanetriol, pentaerythritol, trimethylolmelamine and derivatives thereof and polyoxypropylene triol. Examples of the glycols include (poly)alkylene glycols such as tetramethylene glycol, hexamethylene glycol, ethylene glycol, diethylene glycol, triethylene glycol, tetraethylene glycol, polyethylene glycol, propylene glycol, dipropylene glycol, tripropylene glycol, polypropylene glycol, (poly)tetramethylene glycol and neopentyl glycol; and an ethylene glycol-propylene glycol copolymer. One or more of the above-mentioned polyether polyols can be used for the synthesis of the water-soluble urethane resin. Among the above-mentioned polyether polyols, polyethylene glycol and polypropylene glycol are preferable.

Examples of the polyester polyol include acid esters. Examples of the acid component constituting the acid ester include aromatic dicarboxylic acids such as phthalic acid, naphthalene dicarboxylic acid, biphenyl dicarboxylic acid and tetrahydrophthalic acid; alicyclic dicarboxylic acid such as hydrogenated products of these aromatic dicarboxylic acids; aliphatic dicarboxylic acids such as malonic acid, succinic acid, tartaric acid, oxalic acid, glutaric acid, adipic acid, pimelic acid, suberic acid, azelaic acid, sebacic acid, alkylsuccinic acid, linolenic acid, maleic acid, fumaric acid, mesaconic acid, citraconic acid and itaconic acid. Anhydrides, salts and derivatives (alkyl esters, acid halides) thereof can also be used as the acid. Examples of the component forming an ester with the acid component include polyols such as diols and triols; glycols such as (poly)alkylene glycols. Examples of the polyols and the glycols include polyols and glycols exemplified as the above-mentioned components constituting the polyether polyol. One or more of the above-mentioned polyester polyols can be used for the synthesis of the water-soluble urethane resin.

Polycarbonate polyol prepared by a well-known method can be used as the polycarbonate polyol. Specific examples include alkane diol-based polycarbonate diols such as poly(hexamethylene carbonate) diol. Examples also include polycarbonate diol obtained by reacting carbonate components such as alkylene carbonate, diaryl carbonate, and dialkyl carbonate; or phosgene with an aliphatic diol component. One or more of the above-mentioned polycarbonate polyols can be used for the synthesis of the water-soluble urethane resin.

The polyol having acid groups is a polyol containing acid groups in the structure. Examples of the acid groups include a carboxylic acid group, a sulfonic acid group, a phosphoric acid group and a phosphonic acid group. The acid group may be in the form of a salt. Examples of the cation constituting the salt include ions of lithium, sodium, potassium, ammonium and organic ammonium. The acid group is preferably a carboxylic acid group. Examples of the polyol having carboxylic acid groups include dimethylolacetic acid, dimethylolpropionic acid, dimethylolbutanoic acid and dimethylolbutyric acid. One or more of the above-mentioned polyols having acid groups can be used for the synthesis of the water-soluble urethane resin. Among the polyols having acid groups, dimethylolpropionic acid is preferable.

Examples of the poly amine include monoamines having multiple hydroxy groups such as dimethylolethylamine, diethanolmethylamine, dipropanolethylamine and dibutanolmethylamine; difunctional polyamines such as ethylenediamine, propylenediamine, hexylenediamine, isophoronediamine, xylylenediamine, diphenylmethanediamine, hydrogenated diphenylmethanediamine and hydrazine; and tri- or more functional polyamines such as diethylenetriamine, triethylenetetramine, tetraethylenepentamine, polyamide polyamine and polyethylene polyimine. One or more of the above-mentioned polyamines can be used for the synthesis of the water-soluble urethane resin. Note that the compounds having multiple hydroxy groups and one “amino group or imino group” are also enumerated as “polyamines” for convenience.

A crosslinking agent and a chain extender can be used for the synthesis of the water-soluble urethane resin. The crosslinking agent is commonly used for the synthesis of the prepolymer. The chain extender is commonly used for the elongation reaction of the prepolymer synthesized beforehand. Basically, the crosslinking agent or the chain extender are optionally selected from the group consisting of water, polyisocyanates, polyols and polyamines depending on the purpose such as crosslinking or chain extension. The chain extender that enables crosslinking the water-soluble urethane resin is also usable.

### (Polyethylene Wax)

The ink contains polyethylene wax. If the polyethylene wax is incorporated into the ink, an image having high flexibility and high abrasion resistance is recordable. The polyethylene wax mentioned herein may be a composition containing a component other than polyethylene wax, or may be polyethylene wax itself. The polyethylene wax may be used alone or in combination two or more.

The content (% by mass) of the polyethylene wax in the aqueous ink is preferably 0.05% by mass or more to 5.00% by mass or less based on the total mass of the ink. If the content of the polyethylene wax in the ink is 0.05% by mass or more, the abrasion resistance of the image is likely to be further improved. Meanwhile, if the content of the polyethylene wax in the ink is 5.00% by mass or less, the intermittent ejection stability of the ink is likely to be further enhanced.

The melting point of the polyethylene wax is preferably 50° C. or more to 200° C. or less, more preferably 70° C. or more to 180° C. or less, further preferably 90° C. or more to 180° C. or less. The melting point of the polyethylene wax can be measured by a differential scanning calorimeter (DSC).

The polyethylene wax is preferably dispersed in the ink in the form of a particle (wax particle). The cumulative 50% particle diameter in volume-based particle size distribution (nm) of the polyethylene wax is preferably 10 nm or more to 200 nm or less, more preferably 30 nm or more to 150 nm or less, further preferably 30 nm or more to 100 nm or less. The cumulative 50% particle diameter in volume-based particle size distribution (D₅₀) of the polyethylene wax can be determined by dynamic light scattering. The cumulative 50% particle diameter in volume-based particle size distribution is a particle diameter at which the frequency integrated from the small particle size side is 50% based on the total volume of the measured particle on a cumulative curve of particle diameter.

In order to disperse the polyethylene wax in the ink, a dispersant for dispersing the polyethylene wax can be incorporated into the ink. Examples of the dispersant for the polyethylene wax include surfactants and resins having hydrophilic groups such as a sulfonic acid group or a carboxylic acid group. Examples of the resins having hydrophilic groups include resins to which hydrophilic groups are graft-bonded; and resins having units derived from a hydrophilic monomer and units derived from a monomer having hydrophobic moieties. The dispersant for the polyethylene wax may be used alone or in combination two or more.

Examples of the surfactant usable as the dispersant for the polyethylene wax include anionic surfactants and nonionic surfactants. Examples of the anionic surfactants include carboxylates, sulfonates, sulfate ester salts and phosphate ester salts. Specific examples include alkyl benzene sulfonate, polyoxyethylene alkyl ether sulfate ester salts and polyoxyethylene alkyl ether sulfonate. Examples of the nonionic surfactant include polyoxyethylene alkyl ethers such as polyoxyethylene lauryl ether, polyoxyethylene cetyl ether and polyoxyethylene oleyl ether; and ethylene oxide adduct of acetylene glycol. Examples of the resin that has the hydrophilic group and is usable as the dispersant for the polyethylene wax include acrylic resin having a unit derived from (meth)acrylic acid such as an ethylene-acrylic acid copolymer.

### (Water-Soluble Organic Solvent)

The ink contains a water-soluble organic solvent. The water-soluble organic solvent contains at least one selected from the group consisting of glycol and glycol ether. The present invention uses the glycol or the glycol ether having a vapor pressure of 1.0 Pa or more at 20° C. and a polar term, δ_{P}, of 10.0 MPa^{1/2} or less as the Hansen solubility parameter.

The total content (% by mass) of the above-mentioned glycol and glycol ether in the aqueous ink is preferably 0.50% by mass or more to 15.00% by mass or less further preferably 1.00% by mass or more to 12.00% by mass or less based on the total mass of the ink. If the total content of the above-mentioned glycol and glycol ether in the ink is 1.00% by mass or more, this is likely to enhance the effect of moving the pigment dispersion liquid to portions distant from the ejection orifice and further improve the intermittent ejection stability. Meanwhile, if the total content of the above-mentioned glycol and glycol ether in the ink is 12.00% by mass or less, the abrasion resistance of the image immediately after the recording is likely to be further enhanced.

The vapor pressure of the above-mentioned glycol and glycol ether at 20° C. is 1.0 Pa or more, and preferably 3.0 Pa or more. If the vapor pressure of the glycol and glycol ether at 20° C. is less than 1.0 Pa, the water-soluble organic solvent does not fully evaporate immediately after the recording, so that the abrasion resistance of the image immediately after the recording is deteriorated. If the vapor pressure of the glycol and the glycol ether at 20° C. is 3.0 Pa or more, the abrasion resistance of the image immediately after the recording is likely to be further enhanced. The vapor pressure of the glycol or the glycol ether at 20° C. is preferably 30.0 Pa or less, further preferably 10.0 Pa or less. If the vapor pressure of the glycol and the glycol ether at 20° C. is 30.0 Pa or less, furthermore 10.0 Pa or less, the evaporation of the water-soluble organic solvent near the ejection orifice is suppressed to some extent, so that the intermittent ejection stability is likely to be further enhanced. The vapor pressure (Pa) at 20° C. can be a value to be measured by the static method.

The above-mentioned glycol and glycol ether has a polar member, δ_{P}, of 10.0 MPa^{1/2} or less as the Hansen solubility parameter. If the glycol and the glycol ether have a polar member, δ_{P}, of more than 10.0 MPa^{1/2} as the Hansen solubility parameter, this has an insufficient effect of moving the pigment dispersion liquid to portions distant from the ejection orifice to increase the viscosity of the ink near the ejection orifice, resulting in a deterioration in intermittent ejection stability. The glycol and the glycol ether have a polar term, δ_{P}, of preferably 9.5 MPa^{1/2} or less, further preferably 9.0 MPa^{1/2} or less as the Hansen solubility parameter. Although the lower limit of the polar term δ_{P} of the glycol and the glycol ether as the Hansen solubility parameter may be any value, the polar term δ_{P} is preferably 4.0 MPa^{1/2} or more. If the polar term δ_{P} is 4.0 MPa^{1/2} or more, the solubility of the glycol and the glycol ether in water is improved, so that the intermittent ejection stability can be further improved.

Examples of the glycol having a vapor pressure of 1.0 Pa or more at 20° C. and a polar term, δ_{P}, of 10.0 MPa^{1/2} or less as the Hansen solubility parameter include the following. That is, examples include 1,2-butanediol (2.7 Pa/9.0 MPa^{1/2}), 1,3-butanediol (8.0 Pa/8.1 MPa^{1/2}), 1,2-pentanediol (1.5 Pa/7.8 MPa^{1/2}) and 1,3-pentanediol (1.3 Pa/8.2 MPa^{1/2}). Examples of the glycol ether having a vapor pressure of 1.0 Pa or more at 20° C. and a polar term, δ_{P}, of 10.0 MPa^{1/2} or less as the Hansen solubility parameter include the following. That is, examples include ethylene glycol monobutyl ether (100.0 Pa/5.1 MPa^{1/2}), diethylene glycol monomethyl ether (30.0 Pa/7.8 MPa^{1/2}), diethylene glycol monoethyl ether (13.0 Pa/9.2 MPa^{1/2}), diethylene glycol monobutyl ether (3.0 Pa/7.0 MPa^{1/2}) and triethylene glycol monomethyl ether (10.0 Pa/7.6 MPa^{1/2}). The parenthetical numbers added to the glycols and the glycol ethers indicate (the vapor pressure at 20° C./the polar term δ_{P} as the Hansen solubility parameter).

Examples of the water-soluble organic solvent not corresponding to the above-mentioned glycol and the glycol ether include ethylene glycol (6.5 Pa/11.0 MPa^{1/2}), 1,2-propanediol (10.6 Pa/10.4 MPa^{1/2}), 1,4-butanediol (1.0 Pa/11.0 MPa^{1/2}), 1,2-hexanediol (0.6 Pa/7.1 MPa^{1/2}), 1,6-hexanediol (less than 0.1 Pa/8.4 MPa^{1/2}), triethylene glycol monoethyl ether (0.3 Pa/7.1 MPa^{1/2}), glycerin (less than 0.1 Pa/11.3 MPa^{1/2}), 3-chloroaniline (9.0 Pa/7.3 MPa^{1/2}), triethanolamine (1.3 Pa/7.6 MPa^{1/2}), phenethyl alcohol (8.0 Pa/5.6 MPa^{1/2}) and n-octanol (8.7 Pa/5.0 MPa^{1/2}). The parenthetical numbers added to the glycols and the glycol ethers indicate (the vapor pressure at 20° C./the polar term δ_{P} as the Hansen solubility parameter). Naturally, the above-mentioned glycol and glycol ether do not include polyethylene glycol.

### (Polyethylene Glycol)

The ink contains the polyethylene glycol having a number average molecular weight of 200 or more. The polyethylene glycol preferably has a number average molecular weight of 600 or more. If the polyethylene glycol has a number average molecular weight of 600 or more, the polyethylene glycol is less likely to permeate a recording medium, so that the abrasion resistance of the image immediately after the recording is likely to be further enhanced. Meanwhile, the polyethylene glycol preferably has a number average molecular weight of preferably 3,000 or less, further preferably 2,000 or less. If the polyethylene glycol has a number average molecular weight of 3,000 or less, furthermore 2,000 or less, an excessive increase in the viscosity of the ink is controlled, so that the intermittent ejection stability is likely to be further enhanced.

The number average molecular weight of the polyethylene glycol can be measured and calculated according to the following procedure. First, 1 g (weighed to the fourth decimal place) of polyethylene glycol to be measured is added to 25 mL of pyridine-phthalic anhydride solution accurately weighed in a flask with a stopper. The stoppered flask is heated in a boiling bath for two hours and left to stand until the temperature thereof is room temperature. The flask is then charged with 50 mL (weighed accurately) of 0.5 mol/L aqueous sodium hydroxide solution and ten drops of phenolphthalein solution for titration. The liquid in the flask is titrated with 0.5 mol/L aqueous sodium hydroxide solution, and a point at which the liquid remains red for 15 seconds is considered to be the end point. The number average molecular weight of the polyethylene glycol can be calculated according to the following expression from the obtained titer M (mL) and the titer R (mL) obtained by a blank test performed in the same way as above except that the polyethylene glycol is not used.

$$Number average molecular weight = \{ ( amount ( g ) of polyethylene glycol ) \times 4,000 \} / \{ ( M - R ) \times 0.5 ( mol / L ) \}$$

The mass ratio of the content (% by mass) of the polyethylene glycol to the total content (% by mass) of the above-mentioned glycol and glycol ether in the aqueous ink is preferably 1.0 or less. If the ratio of the content (% by mass) of the polyethylene glycol ink to the total content (% by mass) of the glycol and the glycol ether is 1.0 or less, the glycol and the glycol ether is scarcely prevented from volatilizing immediately after the recording, so that the abrasion resistance of the image immediately after the recording is likely to be further enhanced.

The content (% by mass) of the polyethylene glycol in the ink is preferably 0.10% by mass or more to 10.00% by mass or less, further preferably 0.50% by mass or more and 5.00% by mass or less based on the total mass of the ink.

### (Aqueous Medium)

The ink is an aqueous ink containing at least water as the aqueous medium. A water-soluble organic solvent other than the above-described glycol and glycol ether (another water-soluble organic solvent) can be also incorporated into the ink as the aqueous medium. It is preferable to use deionized water or ion-exchanged water as the water. The content (% by mass) of the water in the aqueous ink is preferably 50.00% by mass or more to 95.00% by mass or less based on the total mass of the ink. Any water-soluble organic solvent that has been commonly used for ink can be used as the other water-soluble organic solvent. Examples include alcohols, (poly)alkylene glycols, nitrogen-containing compounds and sulfur-containing compounds. The content (% by mass) of the water-soluble organic solvent in the aqueous ink is preferably 3.00% by mass or more to 48.00% by mass or less based on the total mass of the ink. This content of the water-soluble organic solvent includes the content of the glycol and the glycol ether.

### (Other Components)

The ink can contain various additives such as a surfactant, a pH adjustor, an antirust, an antiseptic, a fungicide, an antioxidant, a reduction inhibitor, an evaporation accelerator, a chelating agent and other polymers as needed besides the above-mentioned components. Although a coloring material such as dye can be incorporated into the ink, the coloring material as mentioned above may not usually be incorporated.

### (Physical Properties of Ink)

Since the ink is an aqueous ink to be applied to an ink jet system, it is preferable to control the physical property values thereof appropriately. Specifically, the surface tension of the ink at 25° C. measured by the plate method is preferably 20 mN/m or more to 60 mN/m or less, further preferably 25 mN/m or more to 45 mN/m or less. The viscosity of the ink at 25° C. is preferably 1.0 mPa·s or more to 10.0 mPa·s or less, further preferably 1.0 mPa·s or more to 5.0 mPa·s or less. The pH of the ink at 25° C. is preferably 7.0 or more to 10.0 or less.

### Ink Cartridge

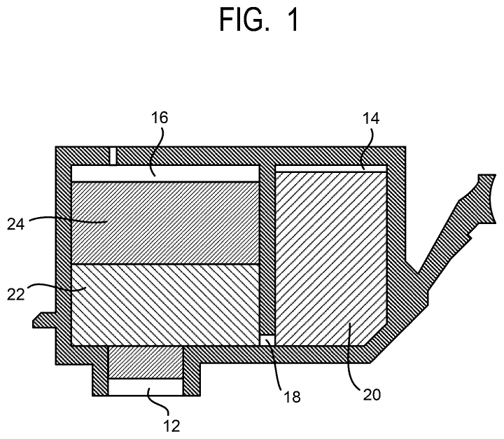

The ink cartridge of the present invention includes an ink and an ink storage portion that stores this ink. The ink stored in this ink storage portion is the aqueous ink of the present invention described above. FIG. 1 is a sectional view illustrating an embodiment of the ink cartridge of the present invention schematically. As illustrated in FIG. 1, the bottom surface of the ink cartridge is provided with an ink supply port 12 for supplying the ink to a recording head. The inside of the ink cartridge is the ink storage portion that stores the ink. The ink storage portion includes an ink storage chamber 14 and an absorbent storage chamber 16. These communicate through a communication port 18. The absorbent storage chamber 16 communicates with the ink supply port 12. The ink storage chamber 14 stores liquid ink 20, and the absorbent storage chamber 16 stores absorbents 22 and 24 that are impregnated with and hold the ink. The ink storage portion may have no ink storage chamber for storing liquid ink, and hold the whole amount of the stored ink with the absorbent. Alternatively, the ink storage portion may have no absorbent, and store the whole amount of ink in liquid state. Moreover, the ink cartridge may be configured to have an ink storage portion and a recording head.

### Ink Jet Recording Method

An ink jet recording method of the present invention is a method including ejecting the aqueous ink of the present invention described above from the recording head in an ink jet system to record an image on a recording medium. Examples of the system for ejecting ink include a system involving applying mechanical energy to ink and a system involving applying thermal energy to ink. The present invention particularly preferably adopts a system involving applying thermal energy to ink to eject the ink. The process of the ink jet recording method may be the same as a known process except that the ink of the present invention is used.

In the ink jet recording method of the present invention, it is preferable to use an ink jet recording apparatus including a recording head which has an ejection orifice for ejecting the ink and a heating unit for heating the recording head. Specific preferable examples of the heating unit include a unit that applies such a pulse (short pulse) as not to result in ink ejection to an electrothermal transducer to heat the recording head. The temperature of the recording head is preferably adjusted to 60° C. or less. If the recording head is warmed to a temperature of 60° C. or less, the volatilization of the water-soluble organic solvent in the ink can be moderately controlled to further enhance the intermittent ejection stability. The temperature of the heated recording head is preferably 30° C. or more.

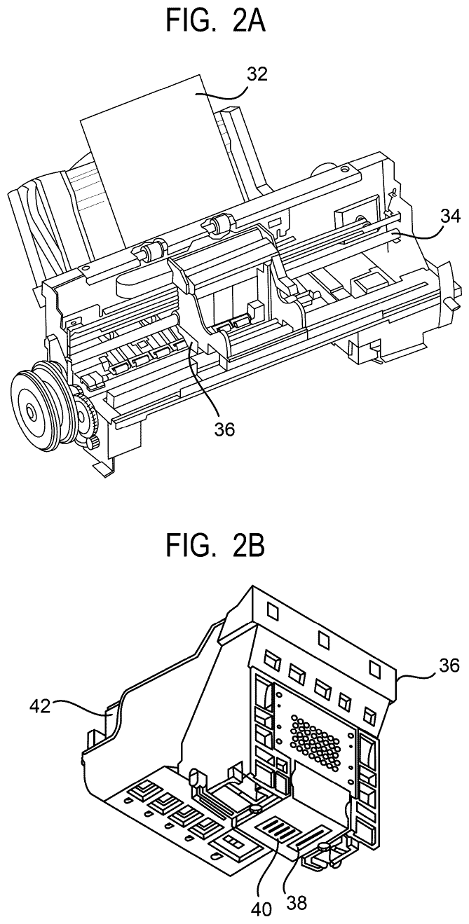

FIGS. 2A and 2B are figures illustrating an exemplary ink jet recording apparatus for the ink jet recording method of the present invention schematically. FIG. 2A is a perspective view of the main parts of the ink jet recording apparatus. FIG. 2B is a perspective view of the head cartridge. The ink jet recording apparatus is provided with a transporting unit (not shown) for conveying a recording medium 32 and a carriage shaft 34. The carriage shaft 34 can be equipped with a head cartridge 36. The head cartridge 36 includes recording heads 38 and 40, and is configured to be installed with an ink cartridge 42. While the head cartridge 36 is conveyed in the main scanning direction along the carriage shaft 34, ink (not shown) is ejected from the recording heads 38 and 40 to the recording medium 32. The transporting unit (not shown) conveys the recording medium 32 in the sub-scanning direction to record an image on the recording medium 32.

Examples of a usable recording medium include, but not limited to, recording media for ink jet printing having coat layers (ink-receiving layer) (for example, glossy paper and matte paper) and recording media not having coat layers (for example, plain papers).

According to one aspect of the present invention, an aqueous ink for ink jet that enables recording an image high in glossiness and abrasion resistance and is high in intermittent ejection stability can be provided. According to another embodiment of the present invention, an ink cartridge and an ink jet recording method using this aqueous ink can be provided.

### EXAMPLES

The present invention will be described in further detail with reference to Examples and Comparative Examples hereinafter. However, unless the present invention departs from the gist thereof, the present invention is not limited by the following Examples in any way. The amounts of components described in “part” and “%” are based on mass unless otherwise specified.

### Synthesis of Urethane Resin

### (Water-Soluble Urethane Resin 1)

A four-necked flask equipped with a stirrer, a thermometer, a nitrogen gas introduction tube and a reflux condenser was provided. This four-necked flask was charged with 41.7 parts of isophorone diisocyanate, 40.1 parts of polypropylene glycol (number average molecular weight: 2,000), 13.2 parts of dimethylolpropionic acid and 200.0 parts of methyl ethyl ketone. These were reacted at 80° C. in a nitrogen atmosphere for six hours. Then, 0.6 parts of ethylenediamine, 2.0 parts of methanol, 2.4 parts of dimethylolpropionic acid and 100.0 parts of methyl ethyl ketone were added. The mixture was reacted at 80° C. until the residual rate of the isocyanate groups confirmed by FT-IR reached a desired residual rate. The reaction liquid was obtained thereby. The obtained reaction liquid was cooled to 40° C., followed by adding ion-exchanged water. While the mixture was rapidly stirred with a homomixer, an aqueous potassium hydroxide solution was added to obtain liquid. The methyl ethyl ketone was distilled off from the obtained liquid to produce the aqueous solution of a water-soluble urethane resin 1, containing the urethane resin (solid matter) at a content of 20.0%.

### (Water-Soluble Urethane Resin 2)

A four-necked flask equipped with a stirrer, a thermometer, a nitrogen gas introduction tube and a reflux condenser was provided. This four-necked flask was charged with 41.7 parts of isophorone diisocyanate, 40.1 parts of a polycarbonate diol (number average molecular weight: 2,000), 13.2 parts of dimethylolpropionic acid and 200.0 parts of methyl ethyl ketone. These were reacted at 80° C. in a nitrogen atmosphere for six hours. Then, 0.6 parts of ethylenediamine, 2.0 parts of methanol, 2.4 parts of dimethylolpropionic acid and 100.0 parts of methyl ethyl ketone were added. The mixture was reacted at 80° C. until the residual rate of the isocyanate groups confirmed by FT-IR reached a desired residual rate. The reaction liquid was obtained thereby. The obtained reaction liquid was cooled to 40° C., followed by adding ion-exchanged water. While the mixture was rapidly stirred with a homomixer, an aqueous potassium hydroxide solution was added to obtain liquid. The methyl ethyl ketone was distilled off from the obtained liquid to produce the aqueous solution of a water-soluble urethane resin 2, containing the urethane resin (solid matter) at a content of 20.0%.

### (Water-Soluble Urethane Resin 3)

Synthesis was performed with reference to “Synthesis Example 9: Synthesis of water-soluble acrylic urethane resin (B-1)”, described in Japanese Patent Application Laid-Open No. 2023-060416, using polypropylene glycol (number average molecular weight: 2,000) instead of “polycarbonate polyol C-2090”. An aqueous solution of a water-soluble urethane resin 3 (solid content: 25%) was obtained thereby.

### (Water-Soluble Urethane Resin 4)

A “water-soluble acrylic urethane resin (B-2)” was synthesized with reference to “Synthesis Example 10 Synthesis of water-soluble acrylic urethane resin (B-2)”, described in Japanese Patent Application Laid-Open No. 2023-060416. An aqueous solution of a water-soluble urethane resin 4 (solid content: 25%) was obtained thereby.

### (Urethane Resin Emulsion)

A commercial aqueous dispersion liquid containing a urethane resin particle having a predetermined particle diameter (trade name: “SUPERFLEX 170”, which was available from DKS Co. Ltd., content of resin (solid matter): 33.0%) was used as a urethane resin emulsion.

### Preparation of Polyethylene Wax

### (Synthesis of Ethylene-Acrylic Resin)

A 500-mL four-necked flask equipped with a stirrer, a thermometer, a nitrogen gas introduction tube and a reflux condenser was provided. This four-necked flask was charged with 100.0 parts of polyethylene and 100.0 parts of diethylene glycol monoethyl ether acetate. The mixture was molten in an oil bath maintained at 180° C. in a nitrogen atmosphere. The temperature of the oil bath was adjusted with stirring so that the temperature in the system reached 170° C. Then, 10.0 parts of benzyl acrylate, 5.0 parts of acrylic acid and 0.4 parts of di-t-butyl peroxide were added with stirring. While the temperature in the system was maintained at 170° C., the mixture was reacted for 30 minutes. Benzyl acrylate, acrylic acid and di-t-butyl peroxide were then added in the same amounts. Benzyl acrylate, acrylic acid and di-t-butyl peroxide were added five times in total every 30 minutes in the same way. The temperature in the system was lowered to 50° C., and the pressure was reduced in the flask with an aspirator for one hour to remove the solvent, the unreacted monomer, di-t-butyl peroxide and decomposed di-t-butyl peroxide. After aging for two hours, ethylene glycol monobutyl ether was distilled off under reduced pressure to obtain a resin. To the obtained resin, potassium hydroxide was added in a molecular amount equal to the acid value of the obtained resin in combination with a suitable amount of ion-exchanged water. The mixture was heated to 80° C. for dissolution, resulting in liquid containing ethylene-acrylic resin at a content (solid content) of 20.0%.

### (Dispersion Liquid 1 of Polyethylene Wax)

A four-necked flask equipped with a stirrer, a thermometer, a reflux condenser and a nitrogen gas introduction tube was provided. This four-necked flask was charged with 225 g of ion-exchanged water and 50 g of polyethylene wax. While the temperature was maintained at 90 to 95° C., the mixture was molten and stirred. Then, 25 g of the liquid containing the ethylene-acrylic resin obtained above was added, followed by dispersion treatment using an ultrasonic homogenizer with the temperature maintained at 90 to 95° C. until the cumulative 50% particle diameter in volume-based particle size distribution (D₅₀) reached 100 nm. The mixture was cooled to room temperature to obtain a dispersion. Ion-exchanged water was added to the obtained dispersion, followed by adjusting the solid content to 10.0% to obtain a dispersion liquid 1 of polyethylene wax.

### (Dispersion Liquid 2 of Polyethylene Wax)

A four-necked flask equipped with a stirrer, a thermometer, a reflux condenser and a nitrogen gas introduction tube was provided. This four-necked flask was charged with 225 g of ion-exchanged water and 50 g of polyethylene wax. While the temperature was maintained at 90 to 95° C., the mixture was molten and stirred. Then, 25 g of the liquid containing the ethylene-acrylic resin obtained above was added, followed by dispersion treatment using an ultrasonic homogenizer with the temperature maintained at 90 to 95° C. until the cumulative 50% particle diameter in volume-based particle size distribution (D₅₀) reached 30 nm. The mixture was cooled to room temperature to obtain a dispersion. Ion-exchanged water was added to the obtained dispersion, followed by adjusting the solid content to 10.0% to obtain a dispersion liquid 2 of polyethylene wax.

### [Cumulative 50% Particle Diameter in Volume-Based Particle Size Distribution of Wax Particle]

Table 1 shows characteristics of the obtained dispersion liquids 1 and 2 of polyethylene wax and the trade name “AQUACER 515” (aqueous dispersion liquid of polyethylene wax available from BYK-Chemie GmbH). The wax particles in these dispersion liquids were measured for cumulative 50% particle diameter in volume-based particle size distribution (D₅₀) by the following method. The dispersion liquids of the wax particles were diluted with pure water to obtain samples. The samples were measured for cumulative 50% particle diameter in volume-based particle size distribution (D50) with a particle size analyzer (trade name: “Microtrac WAVE”, which was available from MicrotracBEL Corp.) by dynamic light scattering. The measurement conditions were as follows:
Set Zero: 30 seconds,
Number of measurements: three,
Measurement time: 120 seconds,
Shape: truth sphere, and
Refractive index: 1.59.

TABLE 1
Characteristics of polyethylene wax

| | | Cumulative 50% | |
|---|---|---|---|
| | | particle diameter | |
| Polyethylene | | based on | Concentration |
| wax | Ingredient | volume (D₅₀ (nm)) | (%) |
| 1 | Dispersion liquid 1 | 100 | 10 |
| | of polyethylene wax | | |
| 2 | Dispersion liquid 2 | 30 | 10 |
| | of polyethylene wax | | |
| 3 | AQUACER515 | 55 | 35 |

### Preparation of Pigment Dispersion Liquids

### (Pigment Dispersion Liquid 1)

First, 10.0 parts of C. I. pigment blue 15:3 (trade name “Hostaperm Blue B2G”, which was available from Clariant), 20.0 parts of aqueous solution of a resin dispersant and 70.0 parts of ion-exchanged water were mixed to obtain a mixture. A styrene-acrylic acid copolymer having an acid value of 120 mgKOH/g was neutralized with 10.0% aqueous sodium hydroxide solution to obtain an aqueous solution of a resin dispersant containing a resin (solid matter) at a content of 20.0%. A batch vertical sand mill (available from IMEX Co., Ltd.) was charged with the obtained mixture and filled with 85 parts of zirconia beads of 0.3 mm, followed by dispersion treatment for three hours during water cooling. The mixture was then centrifuged to remove undispersed material containing a coarse particle. Furthermore, the resultant was pressure-filtered through a cellulose acetate filter having a pore size of 1.2 μm (available from ADVANTEC CO., LTD.) to prepare pigment dispersion liquid 1, containing the pigment at a content (solid content) of 10.0% and the resin at a content of 4.0%.

### (Pigment Dispersion Liquid 2)

Pigment dispersion liquid 2 was prepared by the same method as in the preparation of the pigment dispersion liquid 1 except that C. I. pigment blue 15:3 used for the pigment dispersion liquid 1 was changed into carbon black (trade name “MCF88B”, which was available from Mitsubishi Chemical Corporation). The pigment dispersion liquid 2 contained the pigment at a content (solid content) of 10.0% and the resin at a content of 4.0%.

### (Pigment Dispersion Liquid 3)

C. I. pigment blue 15:3 used for the pigment dispersion liquid 1 was changed into a solid solution of C. I. pigment red 202 and C. I. pigment violet 19 (trade name “Cinquasia Magenta D 4500 J”, which was available from Sun Chemical Corporation). Pigment dispersion liquid 3 was prepared by the same method as in the preparation of the pigment dispersion liquid 1 except the change. The pigment dispersion liquids 3 contained the pigment at a content (solid content) of 10.0% and the resin at 4.0%.

### (Pigment Dispersion Liquids 4)

Pigment dispersion liquid 4 was prepared by the same method as in the preparation of the pigment dispersion liquid 1 except that C. I. pigment blue 15:3 used for the pigment dispersion liquid 1 was changed into C. I. pigment yellow 74 (trade name “Hansa yellow 5GX-W”, which was available from Heubach GmbH). The pigment dispersion liquids 4 contained the pigment at a content (solid content) of 10.0% and the resin at 4.0%.

### (Pigment Dispersion Liquids 5)

Pigment dispersion liquid 5 was prepared by the same method as in the preparation of the above-described pigment dispersion liquids 1 except that the styrene-acrylic acid copolymer having an acid value of 120 mgKOH/g and used for the pigment dispersion liquid 1 was changed into a styrene-acrylic acid copolymer having an acid value of 180 mgKOH/g. The pigment dispersion liquids 5 contained the pigment at a content (solid content) of 10.0% and resin at a content of 4.0%.

### (Pigment Dispersion Liquids 6)

With reference to “Production of cyan pigment dispersion liquid”, described in Japanese Patent Application Laid-Open No. 2023-060416, pigment dispersion liquids 6, which was the cyan pigment dispersion liquid, was prepared. The pigment dispersion liquid 6 contained the pigment at a content (solid content) of 15.0% and the resin at a content of 3.0%.

### Preparation of Inks

Components (unit: % by mass) shown in the middle lines of Tables 2 (Tables 2-1 to 2-6) were mixed and fully stirred, followed by pressure filtration through polypropylene filters having a pore size of 1.0 μm (available from ADVANTEC CO., LTD.) to prepare inks. The pigment dispersion liquids and the aqueous solutions of the water-soluble urethane resins of the types (numbers) shown at the upper lines of Tables 2 were used as the pigment dispersion liquids and the aqueous solutions of the water-soluble urethane resins shown in “Pigment dispersion liquid” and “Aqueous solution of water-soluble urethane resin” at the middle lines of Tables 2, respectively. Characteristics of the inks were shown at the lower lines of Tables 2.

The “Vapor pressure (Pa) of specific glycol or glycol ether at 20° C.” and the “Polar term δ_{P} of specific glycol or glycol ether (MPa^{1/2})” at the lower lines of Tables 2 are indicated only for glycols and glycol ethers having a vapor pressure of 1.0 Pa or more at 20° C. and a polar term, δ_{P}, of 10.0 MPa^{1/2} or less as the Hansen solubility parameter. For those that fall outside the range of either of them or those that are not glycols and glycol ethers, “-” is indicated. The “Total content (%) of specific glycol and glycol ether” at the lower lines of Tables 2 is the total content of glycol and glycol ether having a vapor pressure of 1.0 Pa or more at 20° C. and a polar term, δ_{P}, of 10.0 MPa^{1/2} or less as the Hansen solubility parameter. The pHs of the prepared inks were all adjusted to the range of 8.5 to 9.0 with a 0.5 normal aqueous solution of sulfuric acid. Note that although the inks of Examples 1 and 2 have the same composition, Examples 1 and 2 were different in conditions for evaluating the intermittent ejection stability, described below.

The parenthetical numerical values attached to the water-soluble organic solvents shown in Tables 2 represent (vapor pressure at 20° C./polar term δ_{P} as Hansen solubility parameter), respectively. The parenthetical numerical values of the polyethylene glycols represent the number average molecular weights measured by the above-described measuring method, respectively. Furthermore, the “AST499”, shown in Tables 2, is a trade name acrylic resin emulsion (solid content: 40%) (available from Daicel Miraizu Ltd.). The “Acetylenol E100” is a trade name of a nonionic acetylene glycol surfactant (available from Kawaken Fine Chemicals Co., Ltd.). The “SURFYNOL 104” is a trade name of the nonionic acetylene glycol surfactant (available from Nissin Chemical Industry Co., Ltd.). The “TEGO Wet 280” is a trade name of a siloxane surfactant (available from Evonik Japan Co., Ltd.). The “BYK 348” is a trade name of a silicone-based surfactant (available from BYK-Chemie GmbH). The “Proxel GXL” is a trade name of an antiseptic (available from Arch Chemicals, Inc.).

TABLE 2-1
Composition and characteristics of ink

| | Example | | | | | | | | |
|---|---|---|---|---|---|---|---|---|---|
| | 1 | 2 | 3 | 4 | 5 | 6 | 7 | 8 | 9 |
| Type of dispersion liquid (No.) | 1 | 1 | 1 | 2 | 3 | 4 | 5 | 1 | 1 |
| Type of water-soluble urethane resin (No.) | 1 | 1 | 1 | 1 | 1 | 1 | 1 | 1 | 1 |
| Pigment dispersion liquid | 30.00 | 30.00 | 30.00 | 30.00 | 30.00 | 30.00 | 30.00 | 30.00 | 30.00 |
| Aqueous solution of water-soluble urethane | 5.00 | 5.00 | 5.00 | 5.00 | 5.00 | 5.00 | 5.00 | 5.00 | 5.00 |
| resin | | | | | | | | | |
| Urethane resin emulsion | | | | | | | | | |
| AST499 | | | | | | | | | |
| Dispersion liquid 1 of polyethylene wax | 3.00 | 3.00 | 3.00 | 3.00 | 3.00 | 3.00 | | 3.00 | |
| Dispersion liquid 2 of polyethylene wax | | | | | | | 3.00 | | 3.00 |
| AQUACER515 | | | | | | | | | |
| Glycerin (<0.1 Pa, 11.3 MPa^{1/2}) | 5.00 | | 5.00 | 5.00 | 5.00 | 5.00 | 5.00 | 5.00 | 5.00 |
| 1,3-Butanediol (8.0 Pa, 8.1 MPa^{1/2}) | 10.00 | 12.00 | 10.00 | 10.00 | 10.00 | 10.00 | | | |
| Diethylene glycol monobutyl ether | | | | | | | 10.00 | 10.00 | 10.00 |
| (3.0 Pa, 7.0 MPa^{1/2}) | | | | | | | | | |
| 1,2-Pentanediol (1.5 Pa, 7.8 MPa^{1/2}) | | | | | | | | | |
| 1,2-Butanediol (2.7 Pa, 9.0 MPa^{1/2}) | | | | | | | | | |
| Triethylene glycol monomethyl ether | | | | | | | | | |
| (30.0 Pa, 7.8 MPa^{1/2}) | | | | | | | | | |
| Ethylene glycol monobutyl ether | | | | | | | | | |
| (100.0 Pa, 5.1 MPa^{1/2}) | | | | | | | | | |
| 1,2-Hexanediol (0.6 Pa, 7.1 MPa^{1/2}) | | | | | | | | | |
| 1,6-Hexanediol (<0.1 Pa, 8.4 MPa^{1/2}) | | | | | | | | | |
| 1,2-Propanediol (10.6 Pa, 10.4 MPa^{1/2}) | | | | | | | | | |
| 3-Chloroaniline (9.0 Pa, 7.3 MPa^{1/2}) | | | | | | | | | |
| Triethanolamine (1.3 Pa, 7.6 MPa^{1/2}) | | | | | | | | | |
| Phenylethanol (8.0 Pa, 5.6 MPa^{1/2}) | | | | | | | | | |
| n-Octanol (8.7 Pa, 5.0 MPa^{1/2}) | | | | | | | | | |
| Diethylene glycol (2.7 Pa, 12.0 MPa^{1/2}) | | | | | | | | | |
| Triethylene glycol (<0.1 Pa, 12.5 MPa^{1/2}) | | | | | | | | | |
| Polyethylene glycol (200) | | | | | | | | | |
| Polyethylene glycol (600) | | | | | | | | | |
| Polyethylene glycol (2000) | 1.00 | 1.00 | 1.00 | 1.00 | 1.00 | 1.00 | 1.00 | 1.00 | 1.00 |
| Acetylenol E100 | 0.50 | 0.50 | 0.50 | 0.50 | 0.50 | 0.50 | 0.50 | 0.50 | 0.50 |
| SURFYNOL 104 | | | | | | | | | |
| TEGO Wet280 | | | | | | | | | |
| BYK348 | | | | | | | | | |
| Proxel GXL | 0.20 | 0.20 | 0.20 | 0.20 | 0.20 | 0.20 | 0.20 | 0.20 | 0.20 |
| Ion-exchanged water | 45.30 | 48.30 | 45.30 | 45.30 | 45.30 | 45.30 | 45.30 | 45.30 | 45.30 |
| Vapor pressure of specific glycol or | 8.0 | 8.0 | 8.0 | 8.0 | 8.0 | 8.0 | 3.0 | 3.0 | 3.0 |
| glycol ether at 20° C. (Pa) | | | | | | | | | |
| Polar term δ_{P} of specific glycol or | 8.1 | 8.1 | 8.1 | 8.1 | 8.1 | 8.1 | 7.0 | 7.0 | 7.0 |
| glycol ether (MPa^{1/2}) | | | | | | | | | |
| Total content of specific glycol or | 10.00 | 12.00 | 10.00 | 10.00 | 10.00 | 10.00 | 10.00 | 10.00 | 10.00 |
| glycol ether (%) | | | | | | | | | |
| Content of polyethylene glycol (%) | 1.00 | 1.00 | 1.00 | 1.00 | 1.00 | 1.00 | 1.00 | 1.00 | 1.00 |

TABLE 2-2
Composition and characteristics of ink

| | Example | | | | | | |
|---|---|---|---|---|---|---|---|
| | 10 | 11 | 12 | 13 | 14 | 15 | 16 |
| Type of dispersion liquid (No.) | 1 | 1 | 1 | 1 | 1 | 1 | 1 |
| Type of water-soluble urethane resin (No.) | 1 | 1 | 1 | 1 | 1 | 2 | 3 |
| Pigment dispersion liquid | 30.00 | 30.00 | 30.00 | 30.00 | 30.00 | 30.00 | 30.00 |
| Aqueous solution of water-soluble urethane | 5.00 | 5.00 | 5.00 | 5.00 | 5.00 | 5.00 | 4.00 |
| resin | | | | | | | |
| Urethane resin emulsion | | | | | | | |
| AST499 | | | | | | | |
| Dispersion liquid 1 of polyethylene wax | | 3.00 | 3.00 | 3.00 | 3.00 | 3.00 | 3.00 |
| Dispersion liquid 2 of polyethylene wax | | | | | | | |
| AQUACER515 | 0.86 | | | | | | |
| Glycerin (<0.1 Pa, 11.3 MPa^{1/2}) | 5.00 | 5.00 | 10.00 | 5.00 | 5.00 | 5.00 | 5.00 |
| 1,3-Butanediol (8.0 Pa, 8.1 MPa^{1/2}) | | 5.00 | 1.00 | 12.00 | 10.00 | 10.00 | 10.00 |
| Diethylene glycol monobutyl ether | 10.00 | 5.00 | | | | | |
| (3.0 Pa, 7.0 MPa^{1/2}) | | | | | | | |
| 1,2-Pentanediol (1.5 Pa, 7.8 MPa^{1/2}) | | | | | | | |
| 1,2-Butanediol (2.7 Pa, 9.0 MPa^{1/2}) | | | | | | | |
| Triethylene glycol monomethyl ether | | | | | | | |
| (30.0 Pa, 7.8 MPa^{1/2}) | | | | | | | |
| Ethylene glycol monobutyl ether | | | | | | | |
| (100.0 Pa, 5.1 MPa^{1/2}) | | | | | | | |
| 1,2-Hexanediol (0.6 Pa, 7.1 MPa^{1/2}) | | | | | | | |
| 1,6-Hexanediol (<0.1 Pa, 8.4 MPa^{1/2}) | | | | | | | |
| 1,2-Propanediol (10.6 Pa, 10.4 MPa^{1/2}) | | | | | | | |
| 3-Chloroaniline (9.0 Pa, 7.3 MPa^{1/2}) | | | | | | | |
| Triethanolamine (1.3 Pa, 7.6 MPa^{1/2}) | | | | | | | |
| Phenylethanol (8.0 Pa, 5.6 MPa^{1/2}) | | | | | | | |
| n-Octanol (8.7 Pa, 5.0 MPa^{1/2}) | | | | | | | |
| Diethylene glycol (2.7 Pa, 12.0 MPa^{1/2}) | | | | | | | |
| Triethylene glycol (<0.1 Pa, 12.5 MPa^{1/2}) | | | | | | | |
| Polyethylene glycol (200) | | | | | | | |
| Polyethylene glycol (600) | | | | | 1.00 | | |
| Polyethylene glycol (2000) | 1.00 | 1.00 | 1.00 | 1.00 | | 1.00 | 1.00 |
| Acetylenol E100 | 0.50 | 0.50 | 0.50 | 0.50 | 0.50 | 0.50 | 0.50 |
| SURFYNOL 104 | | | | | | | |
| TEGO Wet280 | | | | | | | |
| BYK348 | | | | | | | |
| Proxel GXL | 0.20 | 0.20 | 0.20 | 0.20 | 0.20 | 0.20 | 0.20 |
| Ion-exchanged water | 47.44 | 45.30 | 49.30 | 43.30 | 45.30 | 45.30 | 46.30 |
| Vapor pressure of specific glycol or | 3.0 | 3.0 | 8.0 | 8.0 | 8.0 | 8.0 | 8.0 |
| glycol ether at 20° C. (Pa) | | | 3.0 | | | | |
| Polar term δ_{P} of specific glycol or | 7.0 | 8.1 | 8.1 | 8.1 | 8.1 | 8.1 | 8.1 |
| glycol ether (MPa^{1/2}) | | | 7.0 | | | | |
| Total content of specific glycol or | 10.00 | 10.00 | 1.00 | 12.00 | 10.00 | 10.00 | 10.00 |
| glycol ether (%) | | | | | | | |
| Content of polyethylene glycol (%) | 1.00 | 1.00 | 1.00 | 1.00 | 1.00 | 1.00 | 1.00 |

TABLE 2-3
Composition and characteristics of ink

| | Example | | | | | | |
|---|---|---|---|---|---|---|---|
| | 17 | 18 | 19 | 20 | 21 | 22 | 23 |
| Type of dispersion liquid (No.) | 1 | 1 | 1 | 1 | 1 | 1 | 1 |
| Type of water-soluble urethane resin (No.) | 1 | 1 | 1 | 1 | 1 | 1 | 1 |
| Pigment dispersion liquid | 30.00 | 30.00 | 30.00 | 30.00 | 30.00 | 30.00 | 30.00 |
| Aqueous solution of water-soluble urethane | 5.00 | 5.00 | 5.00 | 5.00 | 5.00 | 5.00 | 5.00 |
| resin | | | | | | | |
| Urethane resin emulsion | | | | | | | |
| AST499 | | | | | | | |
| Dispersion liquid 1 of polyethylene wax | 3.00 | 3.00 | 3.00 | 3.00 | 3.00 | 3.00 | 3.00 |
| Dispersion liquid 2 of polyethylene wax | | | | | | | |
| AQUACER515 | | | | | | | |
| Glycerin (<0.1 Pa, 11.3 MPa^{1/2}) | 5.00 | 10.00 | 5.00 | 5.00 | 5.00 | 5.00 | 5.00 |
| 1,3-Butanediol (8.0 Pa, 8.1 MPa^{1/2}) | 15.00 | 0.50 | | | | 10.00 | 3.00 |
| Diethylene glycol monobutyl ether | | | | | | | |
| (3.0 Pa, 7.0 MPa^{1/2}) | | | | | | | |
| 1,2-Pentanediol (1.5 Pa, 7.8 MPa^{1/2}) | | | | | | | |
| 1,2-Butanediol (2.7 Pa, 9.0 MPa^{1/2}) | | | 10.00 | | | | |
| Triethylene glycol monomethyl ether | | | | 10.00 | | | |
| (30.0 Pa, 7.8 MPa^{1/2}) | | | | | | | |
| Ethylene glycol monobutyl ether | | | | | 10.00 | | |
| (100.0 Pa, 5.1 MPa^{1/2}) | | | | | | | |
| 1,2-Hexanediol (0.6 Pa, 7.1 MPa^{1/2}) | | | | | | | |
| 1,6-Hexanediol (<0.1 Pa, 8.4 MPa^{1/2}) | | | | | | | |
| 1,2-Propanediol (10.6 Pa, 10.4 MPa^{1/2}) | | | | | | | |
| 3-Chloroaniline (9.0 Pa, 7.3 MPa^{1/2}) | | | | | | | |
| Triethanolamine (1.3 Pa, 7.6 MPa^{1/2}) | | | | | | | |
| Phenylethanol (8.0 Pa, 5.6 MPa^{1/2}) | | | | | | | |
| n-Octanol (8.7 Pa, 5.0 MPa^{1/2}) | | | | | | | |
| Diethylene glycol (2.7 Pa, 12.0 MPa^{1/2}) | | | | | | | |
| Triethylene glycol (<0.1 Pa, 12.5 MPa^{1/2}) | | | | | | | |
| Polyethylene glycol (200) | | | | | | 1.00 | |
| Polyethylene glycol (600) | | | | | | | |
| Polyethylene glycol (2000) | 1.00 | 0.50 | 1.00 | 1.00 | 1.00 | | 5.00 |
| Acetylenol E100 | 0.50 | 0.50 | 0.50 | 0.50 | 0.50 | 0.50 | 0.50 |
| SURFYNOL 104 | | | | | | | |
| TEGO Wet280 | | | | | | | |
| BYK348 | | | | | | | |
| Proxel GXL | 0.20 | 0.20 | 0.20 | 0.20 | 0.20 | 0.20 | 0.20 |
| Ion-exchanged water | 40.30 | 50.30 | 45.30 | 45.30 | 45.30 | 45.30 | 48.30 |
| Vapor pressure of specific glycol or | 8.0 | 8.0 | 2.7 | 30.0 | 100.0 | 8.0 | 8.0 |
| glycol ether at 20° C. (Pa) | | | | | | | |
| Polar term δ_{P} of specific glycol or | 8.1 | 8.1 | 9.0 | 7.8 | 5.1 | 8.1 | 8.1 |
| glycol ether (MPa^{1/2}) | | | | | | | |
| Total content of specific glycol or | 15.00 | 0.50 | 10.00 | 10.00 | 10.00 | 10.00 | 3.00 |
| glycol ether (%) | 1.00 | 0.50 | 1.00 | 1.00 | 1.00 | 1.00 | 5.00 |
| Content of polyethylene glycol (%) | | | | | | | |

TABLE 2-4
Composition and characteristics of ink

| | Comparative Example | | | | | | |
|---|---|---|---|---|---|---|---|
| | 1 | 2 | 3 | 4 | 5 | 6 | 7 |
| Type of dispersion liquid (No.) | 1 | 1 | 1 | 1 | 1 | 1 | 1 |
| Type of water-soluble urethane resin (No.) | — | — | 1 | 1 | 1 | 1 | 1 |
| Pigment dispersion liquid | 30.00 | 30.00 | 30.00 | 30.00 | 30.00 | 30.00 | 30.00 |
| Aqueous solution of water-soluble urethane | | | 5.00 | 5.00 | 5.00 | 5.00 | 5.00 |
| resin | | 3.00 | | | | | |
| Urethane resin emulsion | | | | | | | |
| AST499 | 3.00 | 3.00 | | 3.00 | 3.00 | 3.00 | 3.00 |
| Dispersion liquid 1 of polyethylene wax | | | | | | | |
| Dispersion liquid 2 of polyethylene wax | | | | | | | |
| AQUACER515 | 5.00 | 5.00 | 5.00 | 5.00 | 5.00 | 5.00 | 5.00 |
| Glycerin (<0.1 Pa, 11.3 MPa^{1/2}) | 10.00 | 10.00 | 10.00 | 10.00 | | | |
| 1,3-Butanediol (8.0 Pa, 8.1 MPa^{1/2}) | | | | | | | |
| Diethylene glycol monobutyl ether | | | | | | | |
| (3.0 Pa, 7.0 MPa^{1/2}) | | | | | | | |
| 1,2-Pentanediol (1.5 Pa, 7.8 MPa^{1/2}) | | | | | | | |
| 1,2-Butanediol (2.7 Pa, 9.0 MPa^{1/2}) | | | | | | | |
| Triethylene glycol monomethyl ether | | | | | | | |
| (30.0 Pa, 7.8 MPa^{1/2}) | | | | | | | |
| Ethylene glycol monobutyl ether | | | | | | | |
| (100.0 Pa, 5.1 MPa^{1/2}) | | | | | 10.00 | | |
| 1,2-Hexanediol (0.6 Pa, 7.1 MPa^{1/2}) | | | | | | 10.00 | |
| 1,6-Hexanediol (<0.1 Pa, 8.4 MPa^{1/2}) | | | | | | | 10.00 |
| 1,2-Propanediol (10.6 Pa, 10.4 MPa^{1/2}) | | | | | | | |
| 3-Chloroaniline (9.0 Pa, 7.3 MPa^{1/2}) | | | | | | | |
| Triethanolamine (1.3 Pa, 7.6 MPa^{1/2}) | | | | | | | |
| Phenylethanol (8.0 Pa, 5.6 MPa^{1/2}) | | | | | | | |
| n-Octanol (8.7 Pa, 5.0 MPa^{1/2}) | | | | | | | |
| Diethylene glycol (2.7 Pa, 12.0 MPa^{1/2}) | | | | | | | |
| Triethylene glycol (<0.1 Pa, 12.5 MPa^{1/2}) | | | | | | | |
| Polyethylene glycol (200) | | | | | | | |
| Polyethylene glycol (600) | 1.00 | 1.00 | 1.00 | | 1.00 | 1.00 | 1.00 |
| Polyethylene glycol (2000) | 0.50 | 0.50 | 0.50 | 0.50 | 0.50 | 0.50 | 0.50 |
| Acetylenol E100 | | | | | | | |
| SURFYNOL 104 | | | | | | | |
| TEGO Wet280 | | | | | | | |
| BYK348 | 0.20 | 0.20 | 0.20 | 0.20 | 0.20 | 0.20 | 0.20 |
| Proxel GXL | 50.30 | 47.30 | 48.30 | 46.30 | 45.30 | 45.30 | 45.30 |
| Ion-exchanged water | 8.0 | 8.0 | 8.0 | 8.0 | — | — | — |
| Vapor pressure of specific glycol or | | | | | | | |
| glycol ether at 20° C. (Pa) | 8.1 | 8.1 | 8.1 | 8.1 | — | — | — |
| Polar term δ_{P} of specific glycol or | | | | | | | |
| glycol ether (MPa^{1/2}) | 10.00 | 10.00 | 10.00 | 10.00 | 0.00 | 0.00 | 0.00 |
| Total content of specific glycol or | | | | | | | |
| glycol ether (%) | 1.00 | 1.00 | 1.00 | 0.00 | 1.00 | 1.00 | 1.00 |
| Content of polyethylene glycol (%) | | | | | | | |

TABLE 2-5
Composition and characteristics of ink

| | Comparative Example | | | | | | |
|---|---|---|---|---|---|---|---|
| | 8 | 9 | 10 | 11 | 12 | 13 | 14 |
| Type of dispersion liquid (No.) | 1 | 1 | 1 | 1 | 1 | 1 | 1 |
| Type of water-soluble urethane resin (No.) | 1 | 1 | 1 | 1 | 1 | 1 | 1 |
| Pigment dispersion liquid | 30.00 | 30.00 | 30.00 | 30.00 | 30.00 | 30.00 | 30.00 |
| Aqueous solution of water-soluble urethane | 5.00 | 5.00 | 5.00 | 5.00 | 5.00 | 5.00 | 5.00 |
| resin | | | | | | | |
| Urethane resin emulsion | | | | | | | |
| AST499 | 3.00 | 3.00 | 3.00 | 3.00 | 3.00 | 3.00 | 3.00 |
| Dispersion liquid 1 of polyethylene wax | | | | | | | |
| Dispersion liquid 2 of polyethylene wax | | | | | | | |
| AQUACER515 | | | | | | | |
| Glycerin (<0.1 Pa, 11.3 MPa^{1/2}) | 5.00 | 5.00 | 5.00 | 5.00 | 5.00 | 5.00 | 9.00 |
| 1,3-Butanediol (8.0 Pa, 8.1 MPa^{1/2}) | | | | | 10.00 | 10.00 | |
| Diethylene glycol monobutyl ether | | | | | | | |
| (3.0 Pa, 7.0 MPa^{1/2}) | | | | | | | |
| 1,2-Pentanediol (1.5 Pa, 7.8 MPa^{1/2}) | | | | | | | |
| 1,2-Butanediol (2.7 Pa, 9.0 MPa^{1/2}) | | | | | | | |
| Triethylene glycol monomethyl ether | | | | | | | |
| (30.0 Pa, 7.8 MPa^{1/2}) | | | | | | | |
| Ethylene glycol monobutyl ether | | | | | | | |
| (100.0 Pa, 5.1 MPa^{1/2}) | | | | | | | |
| 1,2-Hexanediol (0.6 Pa, 7.1 MPa^{1/2}) | | | | | | | 1.00 |
| 1,6-Hexanediol (<0.1 Pa, 8.4 MPa^{1/2}) | | | | | | | |
| 1,2-Propanediol (10.6 Pa, 10.4 MPa^{1/2}) | | | | | | | |
| 3-Chloroaniline (9.0 Pa, 7.3 MPa^{1/2}) | 10.00 | | | | | | |
| Triethanolamine (1.3 Pa, 7.6 MPa^{1/2}) | | 10.00 | | | | | |
| Phenylethanol (8.0 Pa, 5.6 MPa^{1/2}) | | | 10.00 | | | | |
| n-Octanol (8.7 Pa, 5.0 MPa^{1/2}) | | | | 10.00 | | | |
| Diethylene glycol (2.7 Pa, 12.0 MPa^{1/2}) | | | | | 1.00 | | 5.00 |
| Triethylene glycol (<0.1 Pa, 12.5 MPa^{1/2}) | | | | | | 1.00 | 5.00 |
| Polyethylene glycol (200) | | | | | | | |
| Polyethylene glycol (600) | | | | | | | |
| Polyethylene glycol (2000) | 1.00 | 1.00 | 1.00 | 1.00 | | | |
| Acetylenol E100 | 0.50 | 0.50 | 0.50 | 0.50 | 0.50 | 0.50 | 0.50 |
| SURFYNOL 104 | | | | | | | |
| TEGO Wet280 | | | | | | | |
| BYK348 | | | | | | | |
| Proxel GXL | 0.20 | 0.20 | 0.20 | 0.20 | 0.20 | 0.20 | |
| Ion-exchanged water | 45.30 | 45.30 | 45.30 | 45.30 | 45.30 | 45.30 | 41.50 |
| Vapor pressure of specific glycol or | — | — | — | — | 8.0 | 8.0 | — |
| glycol ether at 20° C. (Pa) | | | | | | | |
| Polar term δ_{P} of specific glycol or | — | — | — | — | 8.1 | 8.1 | — |
| glycol ether (MPa^{1/2}) | | | | | | | |
| Total content of specific glycol or | 0.00 | 0.00 | 0.00 | 0.00 | 10.00 | 10.00 | 0.00 |
| glycol ether (%) | | | | | | | |
| Content of polyethylene glycol (%) | 1.00 | 1.00 | 1.00 | 1.00 | 0.00 | 0.00 | 0.00 |

TABLE 2-6
Composition and characteristics of ink

| | Comparative Example | | | | |
|---|---|---|---|---|---|
| | 15 | 16 | 17 | 18 | 19 |
| Type of dispersion liquid (No.) | 6 | 6 | 6 | 6 | 1 |
| Type of water-soluble urethane resin (No.) | 4 | 4 | 4 | 4 | 1 |
| Pigment dispersion liquid | 33.33 | 33.33 | 33.33 | 33.33 | 50.00 |
| Aqueous solution of water-soluble urethane | 20.00 | 20.00 | 20.00 | 20.00 | 5.00 |
| resin | | | | | |
| Urethane resin emulsion | | | | | |
| AST499 | | | | | 5.00 |
| Dispersion liquid 1 of polyethylene wax | | | | | |
| Dispersion liquid 2 of polyethylene wax | | | | | |
| AQUACER515 | 3.00 | 3.00 | 3.00 | 3.00 | 1.43 |
| Glycerin (<0.1 Pa, 11.3 MPa^{1/2}) | | | | | |
| 1,3-Butanediol (8.0 Pa, 8.1 MPa^{1/2}) | | | | | |
| Diethylene glycol monobutyl ether | | | 5.00 | | |
| (3.0 Pa, 7.0 MPa^{1/2}) | | | | | |
| 1,2-Pentanediol (1.5 Pa, 7.8 MPa^{1/2}) | | 5.00 | | | |
| 1,2-Butanediol (2.7 Pa, 9.0 MPa^{1/2}) | | | | 7.50 | |
| Triethylene glycol monomethyl ether | | | | | |
| (30.0 Pa, 7.8 MPa^{1/2}) | | | | | |
| Ethylene glycol monobutyl ether | | | | | |
| (100.0 Pa, 5.1 MPa^{1/2}) | | | | | |
| 1,2-Hexanediol (0.6 Pa, 7.1 MPa^{1/2}) | 5.00 | | | 5.00 | 5.00 |
| 1,6-Hexanediol (<0.1 Pa, 8.4 MPa^{1/2}) | | | | | |
| 1,2-Propanediol (10.6 Pa, 10.4 MPa^{1/2}) | 15.00 | 15.00 | 15.00 | 7.50 | 10.00 |
| 3-Chloroaniline (9.0 Pa, 7.3 MPa^{1/2}) | | | | | |
| Triethanolamine (1.3 Pa, 7.6 MPa^{1/2}) | 1.00 | 1.00 | 1.00 | 1.00 | |
| Phenylethanol (8.0 Pa, 5.6 MPa^{1/2}) | | | | | |
| n-Octanol (8.7 Pa, 5.0 MPa^{1/2}) | | | | | |
| Diethylene glycol (2.7 Pa, 12.0 MPa^{1/2}) | | | | | |
| Triethylene glycol (<0.1 Pa, 12.5 MPa^{1/2}) | | | | | |
| Polyethylene glycol (200) | | | | | |
| Polyethylene glycol (600) | | | | | |
| Polyethylene glycol (2000) | | | | | |
| Acetylenol E100 | 0.50 | 0.50 | 0.50 | 0.50 | |
| SURFYNOL 104 | 1.00 | 1.00 | 1.00 | 1.00 | |
| TEGO Wet280 | 1.00 | 1.00 | 1.00 | 1.00 | |
| BYK348 | | | | | 1.00 |
| Proxel GXL | | | | | |
| Ion-exchanged water | 20.17 | 20.17 | 20.17 | 20.17 | 22.57 |
| Vapor pressure of specific glycol or | — | 1.5 | 3.0 | 2.7 | — |
| glycol ether at 20° C. (Pa) | | | | | |
| Polar term δ_{P} of specific glycol or | — | 7.8 | 7.0 | 9.0 | — |
| glycol ether (MPa^{1/2}) | | | | | |
| Total content of specific glycol or | 0.00 | 5.00 | 5.00 | 7.50 | 0.00 |
| glycol ether (%) | | | | | |
| Content of polyethylene glycol (%) | 0.00 | 0.00 | 0.00 | 0.00 | 0.00 |

### Evaluation

An ink cartridge was filled with each of the inks obtained above, and the ink cartridge was set in an ink jet recording apparatus (converted apparatus of trade name: “PIXUS PRO-10S”, which was available from Canon Marketing Japan Inc.) equipped with a recording head for ejecting the ink by thermal energy. An image recorded under the condition that 30 ng of an ink drop is applied to a unit region of 1/600 inches× 1/600 inches is defined as an image having a recording duty of 100%. In these evaluations, “AA”, “A”, “B”, “B1” and “B2” were considered to be acceptable levels, and “C” was considered to be unacceptable based criteria for evaluating the following items. Tables 3 (Table 3-1 and Table 3-2) show the results of evaluation.

### (Glossiness)

Patterns including a solid image with 5 cm×5 cm at a record duty of 100% was recorded on recording media (trade name: “Canon photographic paper, glossy gold GL-101”, which was available from Canon Marketing Japan Inc.) with the above-mentioned ink jet recording apparatus to obtain recorded materials. Two fluorescent lamps disposed at an interval of 10 cm were used as observation light sources, and the shapes of the fluorescent lamps were projected on each recorded image from a distance of 2 m. The shapes of the fluorescent lamps reflected on the image were visually confirmed under the conditions of an angle of illumination of 45 degrees and an angle of observation of 45 degrees to evaluate the glossiness of the image according to evaluation criteria shown below.
A: The shapes of the two fluorescent lamps were clearly projected on the image, or the edges thereof were slightly blurred.
C: The projected shapes of the two fluorescent lamps were not defined.

### (Abrasion Resistance Immediately After Recording)

Patterns including a solid image with 5 cm×5 cm at a record duty of 100% was recorded on recording media (trade name: “Canon photographic paper, glossy gold GL-101”, which was available from Canon Marketing Japan Inc.) with the above-mentioned ink jet recording apparatus to obtain recorded materials. Each image was lightly rubbed with the nail ten minutes after the recording and visually observed to evaluate the abrasion resistance immediately after the recording of the image.
A: The image was not damaged.
B: Although the image was damaged, the ground was not exposed.
C: The image was damaged, so that the ground was exposed.

### (Intermittent Ejection Stability)

Solid images having a record duty of 100% were recorded with the above-mentioned ink jet recording apparatus. Fifty images were recorded under the condition that every image was recorded, followed by cleaning once. That is, cleaning was conducted 50 times. Glossy paper (trade name: “Canon photographic paper, glossy gold GL-101”, which was available from Canon Marketing Japan Inc.) was used as the recording medium. The recording conditions were a temperature of 15° C. and a relative humidity of 10%. After the recording of the 50 images (cleaning 50 times), the apparatus was left to stand for 20 seconds with the cap for covering the ejection orifice of the recording head removed. Letters having sizes of 5 points, 8 points and 10 points were then recorded without cleaning. If the recording head was heated (short-pulse heating was performed), the electrothermal transducer was driven so slightly as not to eject the ink, so that the recording head was heated to 40° C., followed by recording the images. Meanwhile, if the recording head was not heated (short-pulse heating was not performed), the recording head was not heated (kept warm). The recorded letters were visually confirmed to evaluate the intermittent ejection stability according to the evaluation criteria shown below. A smaller faint letter is more difficult to read.
AA: None of the letters were faint.
A: Although all the letters were slightly faint, the letter having a size of 5 points, the letter having a size of 8 points and the letter having a size of 10 points were readable.
B1: All the letters were slightly faint. Although the letter having a size of 5 points was unreadable, the letter having a size of 8 points and the letter having a size of 10 points were readable.
B2: All the letters were slightly faint. Although the letter having a size of 5 points and the letter having a size of 8 points were unreadable, the letter having a size of 10 points was readable.
C: All the letters were very faint, the letter having a size of 5 points, the letter having a size of 8 points and the letter having a size of 10 points were unreadable.

TABLE 3-1
Results of evaluation

| | | | | Abrasion | |
|---|---|---|---|---|---|
| | | | | resistance | |
| | | | | immediately | Intermittent |
| | | Short-pulse | | after | ejection |
| | | heating | Glossiness | recording | stability |
| Example | 1 | Not performed | A | A | A |
| | 2 | Not performed | A | A | A |
| | 3 | Performed | A | A | AA |
| | 4 | Not performed | A | A | A |
| | 5 | Not performed | A | A | A |
| | 6 | Not performed | A | A | A |
| | 7 | Not performed | A | A | A |
| | 8 | Not performed | A | A | A |
| | 9 | Not performed | A | A | A |
| | 10 | Not performed | A | A | A |
| | 11 | Not performed | A | A | A |
| | 12 | Not performed | A | A | A |
| | 13 | Not performed | A | A | A |
| | 14 | Not performed | A | A | A |
| | 15 | Not performed | A | B | A |
| | 16 | Not performed | A | B | A |
| | 17 | Not performed | A | B | A |
| | 18 | Not performed | A | A | B1 |
| | 19 | Not performed | A | B | A |
| | 20 | Not performed | A | A | B1 |
| | 21 | Not performed | A | A | B2 |
| | 22 | Not performed | A | B | A |
| | 23 | Not performed | A | B | A |

TABLE 3-2
Results of evaluation

| | | | | Abrasion | |
|---|---|---|---|---|---|
| | | | | resistance | |
| | | | | immediately | Intermittent |
| | | Short-pulse | Glossi- | after | ejection |
| | | heating | ness | recording | stability |
| Comparative | 1 | Not performed | C | A | A |
| Example | 2 | Not performed | C | A | A |
| | 3 | Not performed | A | C | A |
| | 4 | Not performed | A | C | C |
| | 5 | Not performed | A | C | A |
| | 6 | Not performed | A | C | A |
| | 7 | Not performed | A | A | C |
| | 8 | Not performed | A | A | C |
| | 9 | Not performed | A | A | C |
| | 10 | Not performed | A | A | C |
| | 11 | Not performed | A | A | C |
| | 12 | Not performed | A | C | A |
| | 13 | Not performed | A | C | A |
| | 14 | Not performed | A | C | C |
| | 15 | Not performed | A | C | C |
| | 16 | Not performed | A | C | C |
| | 17 | Not performed | A | C | C |
| | 18 | Not performed | A | C | C |
| | 19 | Not performed | A | C | C |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-067428, filed Apr. 18, 2024, and Japanese Patent Application No. 2025-062402, filed Apr. 4, 2025 which are hereby incorporated by reference herein in their entirety.

What is claimed is:

1. An aqueous ink for ink jet, comprising:
a pigment;
a water-soluble urethane resin;
polyethylene wax;
a water-soluble organic solvent and
polyethylene glycol,
wherein the water-soluble organic solvent comprises at least one selected from the group consisting of glycol and glycol ether having a vapor pressure of 1.0 Pa or more at 20° C. and a polar term, δ_{P}, of 10.0 MPa^{1/2} or less as a Hansen solubility parameter, and
the polyethylene glycol has a number average molecular weight of 200 or more.

2. The aqueous ink according to claim 1, wherein the water-soluble urethane resin comprises at least one unit selected from the group consisting of a unit derived from polyethylene glycol and a unit derived from polypropylene glycol.

3. The aqueous ink according to claim 1, wherein the water-soluble urethane resin comprises neither a unit derived from (meth)acrylic acid nor a unit derived from alkyl (meth)acrylate ester.

4. The aqueous ink according to claim 1, wherein the total content (% by mass) of the glycol and the glycol ether in the aqueous ink is 1.00% by mass or more to 12.00% by mass or less based on the total mass of the ink.

5. The aqueous ink according to claim 1, wherein the vapor pressure of the glycol and the glycol ether at 20° C. is 3.0 Pa or more.

6. The aqueous ink according to claim 1, wherein the vapor pressure of the glycol and the glycol ether at 20° C. is 30.0 Pa or less.

7. The aqueous ink according to claim 1, wherein the vapor pressure of the glycol and the glycol ether at 20° C. is 10.0 Pa or less.

8. The aqueous ink according to claim 1, wherein the polyethylene glycol has a number average molecular weight of 600 or more.

9. The aqueous ink according to claim 1, wherein a mass ratio of a content (% by mass) of the polyethylene glycol to the total content (% by mass) of the glycol and the glycol ether in the aqueous ink is 1.0 or less.

10. An ink cartridge comprising:
an ink and
an ink storage portion that stores the ink,
wherein the ink is the aqueous ink according to claim 1.

11. An ink jet recording method, comprising:
ejecting an ink from a recording head in an ink jet system to record an image on a recording medium,
wherein the ink is the aqueous ink according to claim 1.
